(19) United States
(12) Patent Application Publication
(10) Pub. No.: US 2019/0212558 A1
(43) Pub. Date: Jul. 11, 2019

(54) Variable Reflectivity Image Combiner For Wearable Displays

(71) Applicant: North Inc., Kitchener (CA)

(72) Inventors: Patrick Gerard MCGLEW, ROMAINMOTIER (CH); David ZIEGLER, LAUSANNE (CH)

(73) Assignee: North Inc.

(21) Appl. No.: 16/243,822

(22) Filed: Jan. 9, 2019

Related U.S. Application Data
(63) Continuation of application No. 14/977,403, filed on Dec. 21, 2015, now abandoned.
(60) Provisional application No. 62/240,408, filed on Oct. 12, 2015.

(51) Int. Cl. G02B 27/01; G02B 27/58; G02B 5/32

(52) U.S. Cl. CPC G02B 27/0103; G02B 27/58; G02B 27/0172; G02B 2027/0105; G02B 2027/0174; G02B 2027/0118; G02B 2027/0178; G02B 5/32

(57) ABSTRACT

Disclosed herein are devices and methods to provide an appodized holographic combiner lens having a varying reflectivity profile. In particular, a lens to reflect light from a number of input pupils to a number of exit pupils may be provided, where the lens reflects incident light in varying levels based on where on the lens the light is incident.

### CROSS-REFERENCE TO RELATED APPLICATION

This application claims the benefit of U.S. Provisional Application Ser. No. 62/240,408 filed Oct. 12, 2015, entitled “Electro-Mechanical Design for MEMS Scanning Mirror.” which application is incorporated herein by reference in its entirety.

### TECHNICAL FIELD

Embodiments herein generally relate to head worn displays and heads up displays and in particular to image combiners in a holographic wearable display.

### BACKGROUND

Modern display technology may be implemented to provide a head worn display (HWD) or a heads up display (HUD). Such HWDs and/or HUDs can be implemented to provide a display of a virtual image (e.g., images, text, or the like). The virtual image may be provided in conjunction with a real world view. Such HWDs and/or HUDs can be implemented in a variety of contexts, for example, defense, transportation, industrial, entertainment, wearable devices, or the like.

In some HWD and/or HUD displays, the virtual image may be reflected off a projection surface into a user's eye to present the virtual image to the user. With many display form factors (e.g., glasses, helmets, or the like), the projector is offset from the projection surface, resulting in the projected light being incident on the projection surface at an angle. This angle of incidence may affect the intensity of light reflected from the projection surface, and as a result, the intensity of light incident on a user's eye.

### BRIEF DESCRIPTION OF THE DRAWINGS

FIG. 1 illustrates a first example system.

FIG. 2 illustrates an example of a portion of the system of FIG. 1 in greater detail.

FIG. 3 illustrates a first example appodized holographic combiner lens.

FIG. 4 illustrates the first example appodized holographic combiner lens reflecting incident light beams.

FIGS. 5A-5B illustrate an example appodized holographic combiner lens during operation.

FIGS. 6-7 illustrate example intensity and reflectivity profiles for appodized holographic combiner lenses described herein.

FIG. 8 illustrates an example second system.

FIG. 9-10 illustrate example logic flows.

FIG. 11 illustrates an example computer readable medium.

FIG. 12 illustrates an example third system.

### DETAILED DESCRIPTION

Various embodiments may be generally directed to head worn displays (HWDs) and/or heads up displays (HUDs). Specifically, the present disclosure is applicable to HWDs and HUDs having an appodized holographic combiner lens. In particular, the present disclosure provides HWDs and/or HUDs with one or more holographic combiner lenses that have a varying amount (e.g., in the horizontal direction, in the vertical direction, or the like) of reflectivity.

For example, the present disclosure can be implemented as a head worn display having a projection system and a projection surface. The projection system can be offset from the projection surface such that, during operation, the projection system may scan light corresponding to pixels of a virtual image across the projection surface. The projection surface comprises an appodized holographic combiner lens to reflect light in varying amounts based on the location of incidence.

During operation, as the light is scanned across the projection surface, the light may be incident on the projection surface at a number of areas of the lens. Additionally, it is to be appreciated, that the light may be incident on the lens at a number of different angles. In general, optical reflection varies, based on the angle of incidence. Accordingly, the intensity of the reflected light may vary across the lens. However, the present disclosure provides the appodized holographic combiner lens that varies in reflectivity across the lens. Accordingly, an image corresponding to light reflected from the lens may have a uniform intensity and/or brightness. As such, the appodized holographic combiner lens can reflect a virtual image to a viewpoint where the virtual image may have a uniform intensity and/or brightness.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

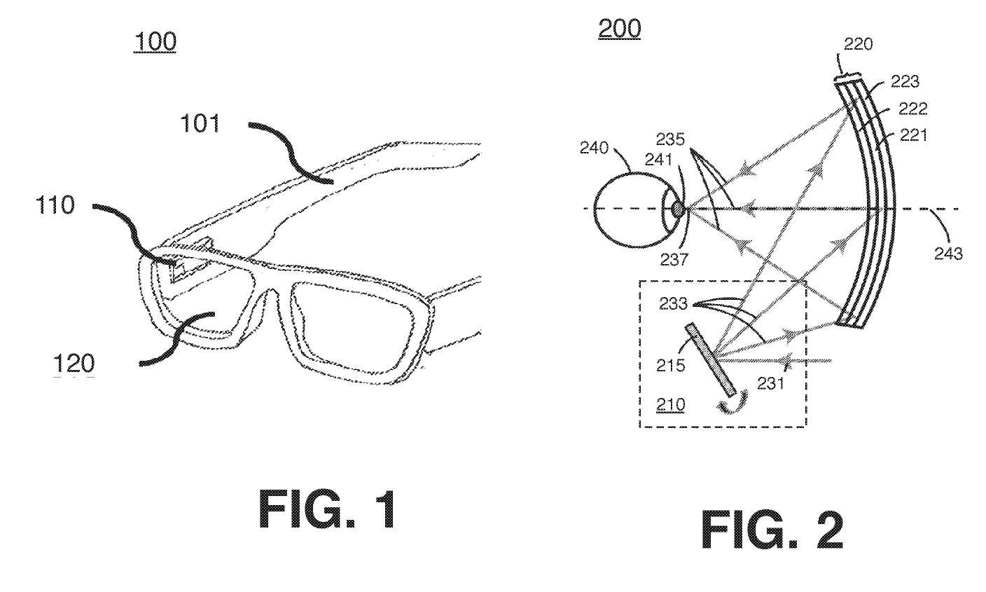

FIG. 1 illustrates an example of device 100 arranged according to the present disclosure. It is noted, that the device of this figure is depicted implemented as a pair of glasses. However, examples are not limited in this context. In particular, the device 100 may be embodied as a pair of glasses (e.g., as depicted), as a pair of binoculars, a monocular device (e.g., scope, or the like) as goggles, in a helmet, in a visor, in a wearable device, in a heads up display, on a windshield, or the like.

In general, the device 100 is configured to provide a virtual image at a viewpoint. In some examples, the virtual image may be provided in conjunction with a real world view. For example, the device 100 includes a glasses frame 101 onto which a projection system 110 is mounted. Additionally, the device 100 includes an appodized holographic combiner lens 120 mounted in the frame 101. During operation, the projection system can project light corresponding to virtual images onto the appodized holographic combiner lens 120. The appodized holographic combiner lens 120 can reflect (or redirect) the light to a user's eye (e.g., proximate to a user's eye, proximate to where a user's eye would or should be during operation, or the like).

In some examples, the appodized holographic combiner lens 120 is configured to both redirect the light scanned across the appodized holographic combiner lens 120 to project a virtual image at a viewpoint and also to transmit light from the external environment to the viewpoint. As such, virtual images and real world images may be viewed simultaneously. It is noted, that although the device is depicted with a single projection system 110 and a single appodized holographic combiner lens 120, the device may include a projection system and appodized holographic combiner lens for each eye. Examples are not limited in this context.

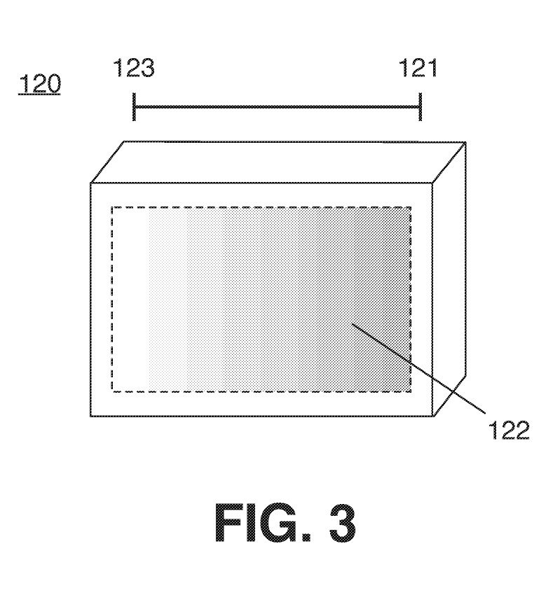

In general, the appodized holographic combiner lens 120 comprises a substrate with a layer of material coated the substrate (e.g., refer to FIG. 2). For example, the appodized holographic combiner lens 120 may comprise a transparent substrate with a photosensitive material (e.g., a photopolymer, a dichromatic gelatin, or the like) coated thereon. As another example, the appodized holographic combiner lens 120 may comprise an opaque substrate with photosensitive material (e.g., a photopolymer, a dichromatic gelatin, or the like) coated thereon. The photosensitive material may be etched, for example, using a holographic recording process, to provide reflective portions or reflective features, which vary in reflectivity based on an angle of incident light. With some examples, a protective layer and/or material may be coated onto the photopolymer, for example, after it has been hologrpahically recorded.

In some examples, the projection system 110 may comprise a scanning mirror or panel microdisplay projector to project image light onto the appodized holographic combiner lens 120. In general, the projection system 110 may comprise a power source, a light source, and a projection system. In some examples, the power source may be a battery. In some examples, the light source may be a laser light source, a light emitting diode (LED) light source, or in general, any light source configured to emit light. In some examples, the projection system is a micropanel projector. In some examples, the projection system is a microelectromechanical system (MEMS) based scanning mirror projection system. In some examples, the projection system 110 may comprise one or more of a signal processing component, a signal interface component, and a graphics processing component, to project light onto the appodized holographic combiner lens 120 to project a virtual image at a viewpoint.

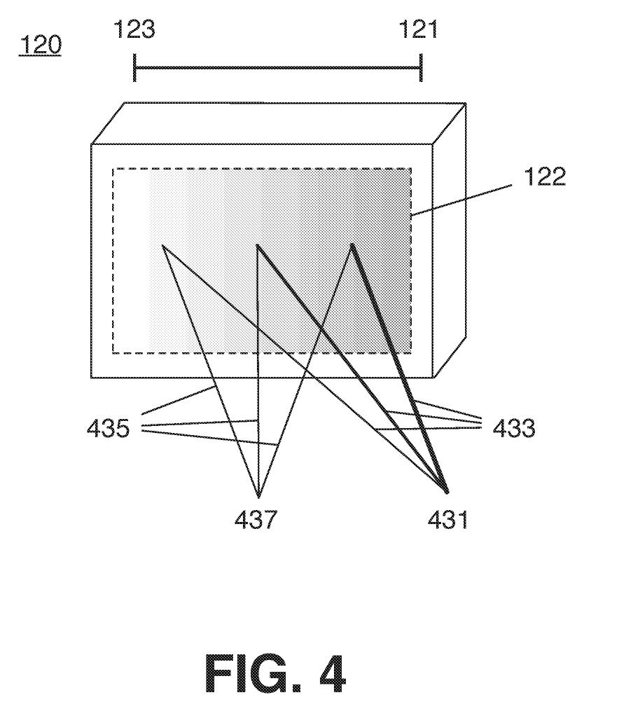

FIG. 2 illustrates a block diagram of a side view of an example optical system 200 for projecting a virtual image at a viewpoint. In some examples, the optical system 200 may be implemented by the device 100 depicted in FIG. 1. Examples, however, are not limited in this context. It is noted, FIG. 2 depicts light from a vertical slice. As such, the reflectivity of the appodized holographic combiner lens is not depicted in this figure. More details about the reflectivity of the appodized holographic combiner lens are given below (e.g., refer to FIGS. 3-4 and 5A-5B).

In general, the system 200 is configured to project light to a viewpoint, or exit pupil 237. The exit pupil 237 is depicted proximate to a user's eye 240. However, this is done for purposes of clarity of explanation and not to be limiting. Furthermore, the present disclosure could be implemented with optical systems that project light to multiple exit pupils. Additionally, it is noted, the optical system 200 is depicted with a scanning light projection system. However, as noted above, the present disclosure could be implemented with standard light projection systems. Examples are not limited in these contexts.

The system 200 includes a projection system 210 including a light source (not shown) to emit a light beam 231 of at least one wavelength. Alternatively, the system 210 may receive light emitted from a source not included in the system. Examples are not limited in this context. The light beams 231 is received by (or incident on) a scanning mirror 215. The scanning mirror 215 rotates about a number of axes to scan the light beam 231 in angles 233. The system 210 is configured to modulate or modify the intensity of the scanned light beam 231 to correspond to a digital image.

The scanning mirror 215 scans the light beam 231 in angels 233 onto (or across) the appodized holographic combiner lens 220. In some examples, the appodized holographic combiner lens 220 comprises a recorded holographic material 221 disposed between two protective layers 222 and 223. The appodized holographic combiner lens 220 is configured to reflect the light 233 into diffracted light 235 to an exit pupil 237. In general, the appodized holographic combiner lens 220 is configured to reflect and diffract the light 233 to the location of an entrance pupil 241 of a user's eye 240. Said differently, the appodized holographic combiner lens 220 reflects the light 233 to the exit pupil 237, which is proximate to the pupil 241 of the eye 240. As depicted, the line of sight 243 of the eye (e.g., corresponding to the eye pupil 241) is aligned with the exit pupil 237. It is noted, that the lens 220 is configured to reflect the light non-uniformly. More particularly, the reflectivity of the lens varies (e.g., in a horizontal direction, in a vertical direction, or the like).

FIG. 3 illustrates a perspective view of an example of the appodized holographic combiner lens 120, arranged according to at least some examples of the present disclosure. In particular, the appodized holographic combiner lens 120 can be implemented to reflect light in varying intensity. Said differently, the reflectivity of the appodized holographic combiner lens 120, or the amount of light reflected from the appodized holographic combiner lens 120, varies based on the area of incidence.

In general, the appodized holographic combiner lens 120 comprises a reflective portion 122 to reflect incident light. More specifically, the reflective portion 122 comprises a number of periodic features (e.g., formed by holographic techniques, or the like) to reflect and diffract incident light. The reflective portion 122 is selective, in that it reflects incident light in varying intensity based on the location on the reflective portion 122 where the light is incident. Accordingly, it may be said the reflective portion is appodized, or changes the function of the reflectivity, in this case, based on the location of incidence. In some examples, the reflective portion may be selectively reflective in the horizontal direction. In some examples, the reflective portion may be selectively reflective in the vertical direction. As depicted in FIG. 3, the reflective portion 310 selectively reflects light in varying intensity based on the area of incidence in the horizontal direction. More specifically, the reflective portion reflects light in different amounts based on where in the horizontal plane, light is incident on the reflective portion 122. For example, light incident on an edge 121 of the reflective portion 122 can be reflected in lesser amounts than light incident on an edge 123 of the reflective portion 122.

With some examples, the reflective portion 122 reflects light in varying amounts linearly across the reflective portion 122. With some examples, the reflective portion 122 reflects light non-linearly across the reflective portion 122. Examples are not limited in this context.

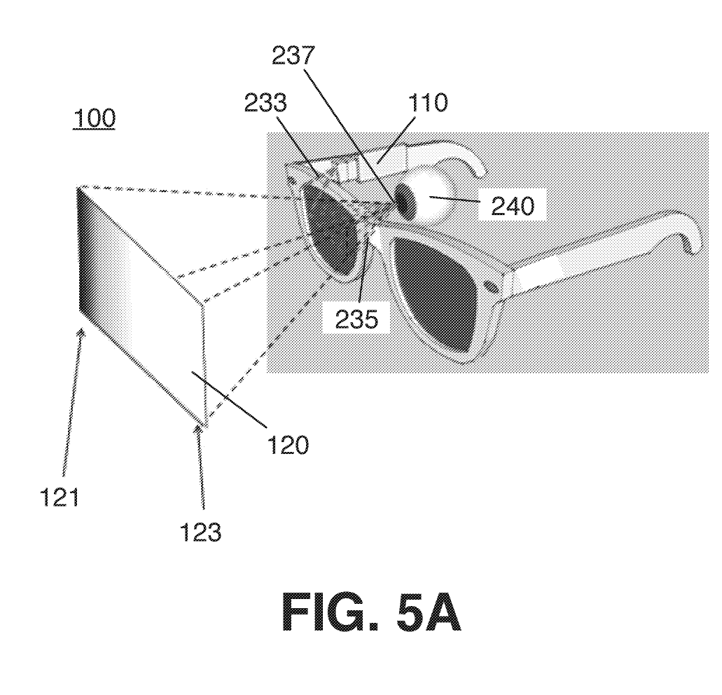

FIG. 4 depicts example optical reflections off the reflective portion 122 of the appodized holographic combiner lens 120. It is important to note, that these optical reflections are depicted in a simplified form to facilitate understanding and that the contract and brightness of the light beams incidence on the appodized holographic combiner lens 120 and the corresponding reflected light beams are exaggerated for clarity of presentation. Examples are not limited in this context.

During operation, light beams, for example light beams 433 can be incident on the reflective portion 122 of the appodized holographic combiner lens 120. In particular, a light source or projection system (e.g., the projection system 110, or the like) can emit light beams 433 from an entrance pupil 431. It is noted, that the light beams 433 are incident on the reflective portion 122 in different angles depending upon where on the reflective portion 122 the light beams 433 are incident. Additionally, the distance between the input pupil (e.g., the light source, scanning mirror, or the like) and the reflective portion 122 differs depending upon where on the reflective portion 122 the light beams 433 are incident. The light beams 433 may have a different intensity, depending upon the angle of incidence and the distance between the input pupil 431 and the reflective portion 122. For purposes of illustration only, in FIG. 4 the intensity is represented by the line width of the lines representing the light beams 433. For example, the light beams 433 are depicted decreasing in intensity from right to left. This is done for purposes of explanation only and not to be limiting. For example, light beams 433 may vary in intensity non-linearly. As another example, light beams 433 may increase in intensity from left to right, or in a vertical manner (e.g., from top to bottom, from bottom to top, or the like).

The reflective portion 122 reflects the incident light beams 433 as light beams 435. However, as the reflective portion has a varying amount of reflectivity, the light beams 433 are reflected in varying amounts, depending upon where the light is incident on the reflective portion 122. In general, the reflective portion 122 reflects incident light beams 433 in an amount to provide a uniform or a substantially uniform intensity in the reflected light beams 435. Said differently, the reflective portion 122 reflects incident light beams 433 as reflected light beams 435 where the reflected light beams 435 have a substantially uniform intensity. For purposes of illustration only, in FIG. 4 the intensity is represented by the line width of the lines representing the reflected light beams 435. For example, the reflected light beams 435 are depicted having a substantially uniform line width, or intensity.

The reflective portion 122 directs the reflected light beams 435 to exit pupil 437. During operation, a projection system (e.g., the projection system 110, or the like) can modulate and/or pulse the light beams 433 to correspond to pixels of an image to be projected to exit pupil 437. Accordingly, due to the appodized nature of the appodized holographic combiner lens 120, and particularly, the reflective portion 122, any image projected to the exit pupil 437 may have a uniform intensity across the image. More specifically, as the reflected light beams 435 are reflected in varying amounts to correct or to provide reflected light beams of a uniform intensity, any corresponding projected image may also have a uniform intensity.

It is worthy to note; the present disclosure may provide for projected images to be lightened or darkened. More specifically, as the images may have a uniform intensity without manipulating the intensity at the light source, the light source may uniformly lighten or darkened the emitted light beams, thereby resulting in a lighter or darker projected image.

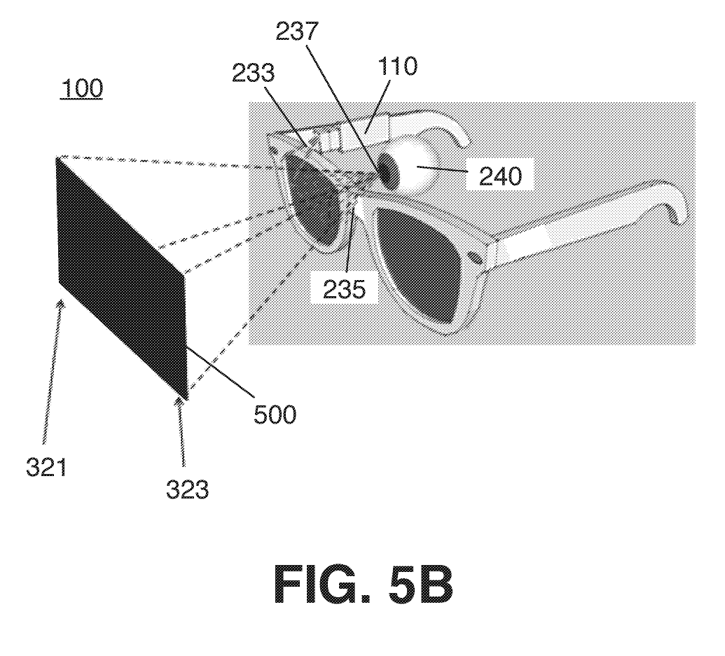

FIGS. 5A-5B illustrate an example of the device 100 comprising the projection system 110 and the appodized holographic combiner lens 120. In particular. FIG. 5A depicts an example of the varying reflectivity of the lens 120 while FIG. 5B depicts an example displayed image.

Turning more specifically to FIG. 5A, the device 100 is depicted with the projection system 110 and eye 240. During operation, the projection system 110 directs (e.g., projects, scans, or the like) light beams 233 onto the appodized holographic combiner lens 120. More specifically, the projection system 110 directs light beams 233 onto the reflective portion 122. It is noted, that the reflective portion 122 is shown in an enlarged format for convenience and clarity.

The reflective portion 122 reflects the light beams 233 as diffracted light 235 at least one exit pupil 237, which can be proximate to the eye 240. As discussed above (e.g., in conjunction with FIGS. 3-4), the reflective portion 122 reflects light in varying amounts, depending upon where on the reflective portion the light is incident, reflectivity of the lens varies across the combiner. For example, the reflectivity of the appodized lens 120 may vary linearly in the horizontal direction of the lens 120. As a specific example, the reflectivity of the reflective portion 122 can vary from least reflective along the vertical edge 121 to most reflective along the vertical edge 123.

It is noted, that although the example here depicts the reflectivity of the lens varying linearly and in the horizontal direction. Examples are not limited in this context. In particular, the reflectivity of the lens 120 may vary non-linearly and/or in another direction, such as, for example, vertically, based on the projection system 120, the angle of incidence of the light 233, the exit pupil(s) of the light, or the like. As discussed above, the reflectivity of the reflective portion 122 of the appodized holographic combiner lens 120 varies to project an image having a substantially uniform intensity. Said differently, the reflectivity varies to reflect diffracted light 235 having a substantially uniform intensity. More specifically, for a first intensity of light (e.g., 233) incident on a first area and a second area of the reflective portion 122 (e.g., the edge 121 and the 123, respectively, or the like), the reflective portion 122 reflects light 235, where the reflected light 235 from both these areas has a substantially uniform intensity.

Turning more specifically to FIG. 5B, as the reflectivity of the reflective portion 122 of the appodized holographic combiner lens 120 varies such that intensity of reflected light is substantially uniform, a projected (or perceived) image 500 may also have uniform intensity. For example, the projected image 500 is depicted. It is noted, that the projected image 500 may correspond to an image projected to exit pupil 237, or the like. However, for purposes of clarity, the image 500 is depicted in enlarged form. As depicted, the projected image has a uniform intensity. More specifically, the intensity of light corresponding to the image 500 is substantially uniform from the vertical edges 521 to 523.

Accordingly, the light reflected to the exit pupils or the image projected to the exit pupils, and therefore, the image perceivable by a user's eye may have a uniform intensity.

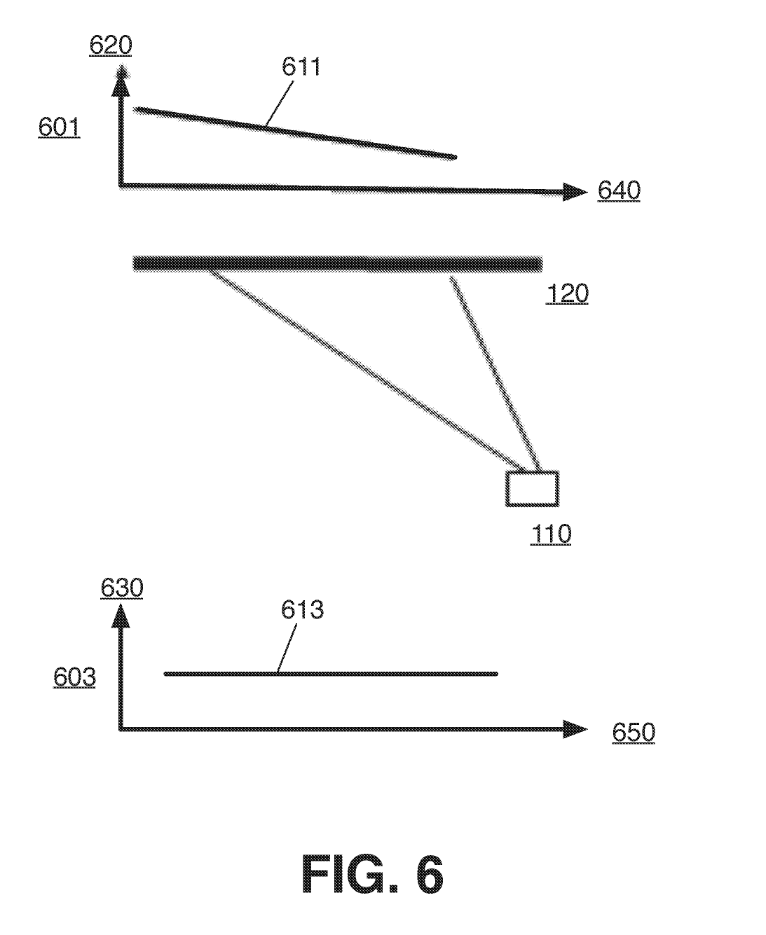

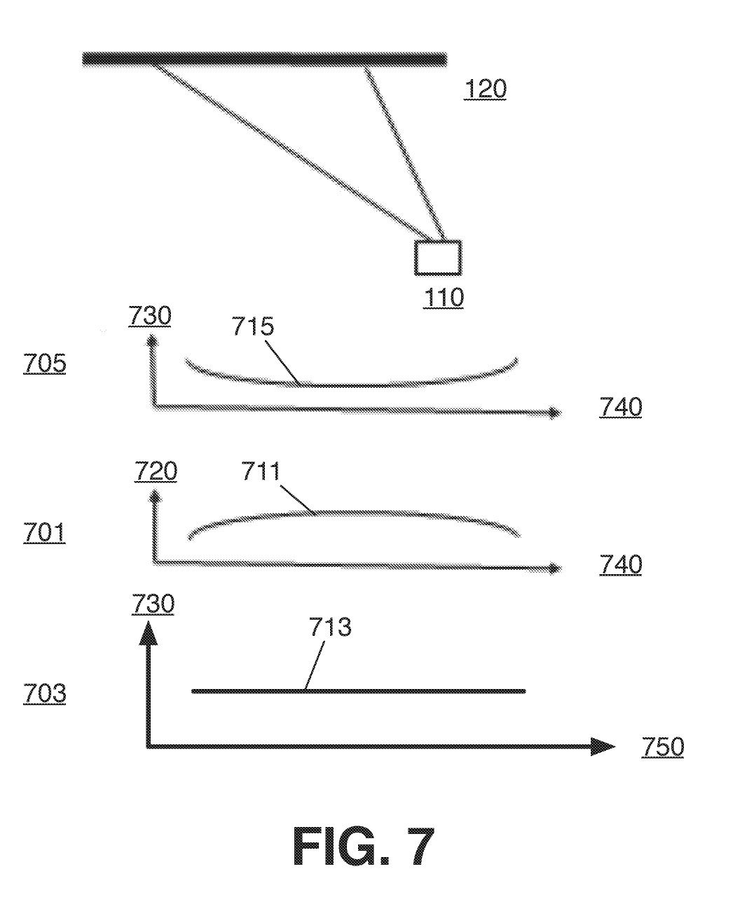

FIGS. 6-7 illustrate graphs of reflexivity profiles and corresponding perceived intensity profiles for example appodized holographic combiner lenses, each arranged according to the present disclosure. In general, FIG. 6 depicts a linearly varying reflexivity profile while FIG. 7 depicts a non-linearly varying reflexivity profile. Each of the reflexivity profiles are depicted with a corresponding perceived image intensity profile.

Turning to FIG. 6, a graph 601 of an appodized holographic combiner lens reflectivity 611 is depicted. Additionally, a graph 603 of a perceived image intensity level 613 is depicted. The graph 601 depicts the reflectivity 611 as an amount of reflexivity 620 (y axis) versus a horizontal position 640 (x axis) on the appodized holographic combiner lens 120. The graph 603 depicts the image intensity 613 as an intensity level 630 (y axis) versus a horizontal position 650 (x axis) of the projected image (e.g., the image 500, or the like). In particular, the reflectivity 611 is depicted as varying (e.g., linearly) across the horizontal position 640 of the appodized holographic combiner lens 120 while the intensity 613 is depicted as being substantially uniform across horizontal position 650 of the image. It is worthy to note, that the horizontal position 640 of the appodized holographic combiner lens 120 may correspond to the horizontal direction 650 of the projected image.

Turning to FIG. 7, a graph 701 of an appodized holographic combiner lens reflectivity 711 is depicted. Additionally, a graph 703 of a perceived image intensity level 713 is depicted. Additionally, a graph 705 of a projected light intensity 715 is depicted. It is worthy to note, that with some examples, the light intensity of light beams (e.g., light beams 233, light beams 433, or the like) incident on the reflective portion 122 of the appodized holographic combiner lens 120 may vary. For example, with some scanning projection systems (e.g., microelectromechanical systems (MEMS) based scanning mirror systems, or the like) the light scanned across the lens 120 may have a varying amount of intensity.

The graph 705 depicts the intensity 715 of light incident on the appodied holographic combiner lens 120 as an intensity level 730 (y axis) versus a horizontal position 740 (x axis) on the appodized holographic combiner lens 120. The graph 701 depicts the reflectivity 711 as an amount of reflexivity 720 (y axis) versus a horizontal position 740 (x axis) on the appodized holographic combiner lens 120. The graph 703 depicts the image intensity 713 as an intensity level 730 (y axis) versus a horizontal position 750 (x axis) of the projected image (e.g., the image 500, or the like).

As depicted, the light intensity 715 varies in intensity 730 non-linearly across the direction 740 while the reflexivity level 711 of the appodized holographic combiner lens 120 varies in reflexivity 720 non-linearly across the direction 540. It is noted, the light intensity 715 varies in an inverse manner to the reflexivity level 711. Accordingly, the intensity level 713 of the projected image may have a substantially uniform intensity 730 across the direction 750. As such, the appodized holographic combiner lens 120 may be provided with a non-linearly varying amount of reflexivity 740 to account for variations in the intensity 730 of the incident light.

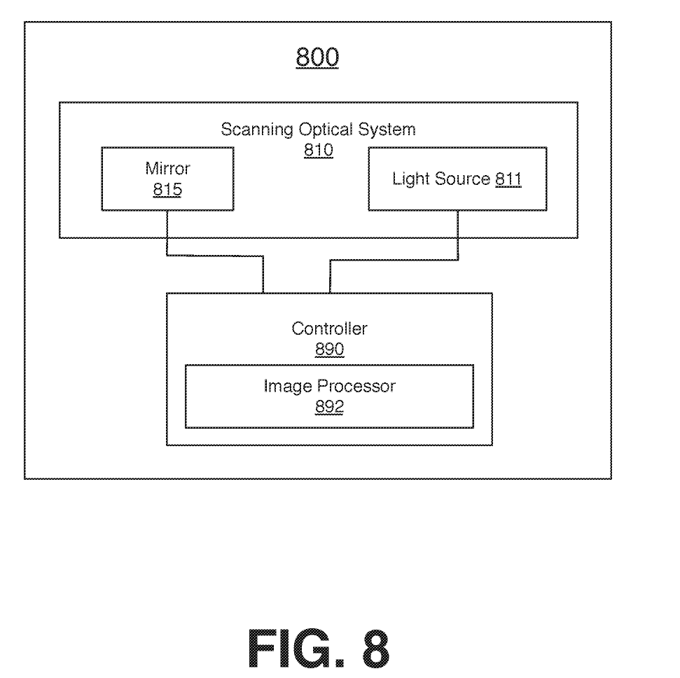

FIG. 8 depicts a block diagram of an optical projection system 800. In some examples, the optical projection system 800 may be implemented as the optical projection system 110 and/or 210 described herein. In general, the optical projection system 800 may be provided to scan light over an appodized holographic combiner lens 120.

In particular, the system 800 may include a scanning optical system 810. The scanning optical systems 810 may include a light source 811 (e.g., a laser, an LED, or the like). Additionally, the system 810 includes a mirror 815. The mirror 815 may be a MEMS based mirror configured to rotate about a number of axes to scan light emitted from the light source across a projection surface (e.g., the lens 120, or the like).

The system 800 may also include a controller 890. In general, the controller 890 may comprise hardware and/or software and may be configured to execute instructions to cause the controller 890 to send one or more control signals to light source 811 and/or the mirror 815 to cause the light source 811 to emit light and the mirror 815 to rotate about a number of axes to project the light over and/or across the lens 120.

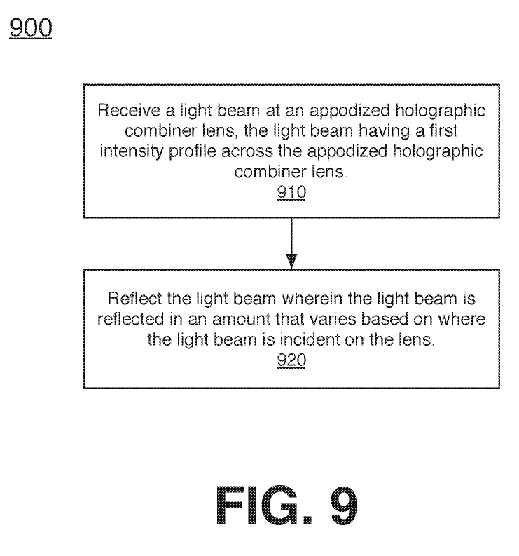

FIG. 9 depicts a logic flow 900 for reflecting light to an exit pupil. The logic flow 900 may begin at block 910. At block 910 “receive a light beam at an appodized holographic combiner lens, the light beam having a first intensity profile across the appodized holographic combiner lens” the lens 120 may receive a light beam (e.g., the light 233, or the like) having a first intensity profile. More specifically, the intensity of the light beam may vary linearly or non-linearly as described herein.

Continuing to block 920 “reflect the light beam wherein the light beam is reflected in an amount that varies based on where the light beam is incident on the lens.” At block 920 the lens 120 reflects the light beam (e.g., light 233) as reflected light (e.g., light 235) where the amount the light is reflected varies based on where the light is incident on the lens 120. In particular, the appodized holographic combiner lens 120 reflects light in varying amounts, based on where on the lens the light is incident. For example, referring to FIG. 4, the reflective portion 122 of the appodized holographic combiner lens 120 reflects light 433 in varying amounts, based on where the light 433 is incident on the lens.

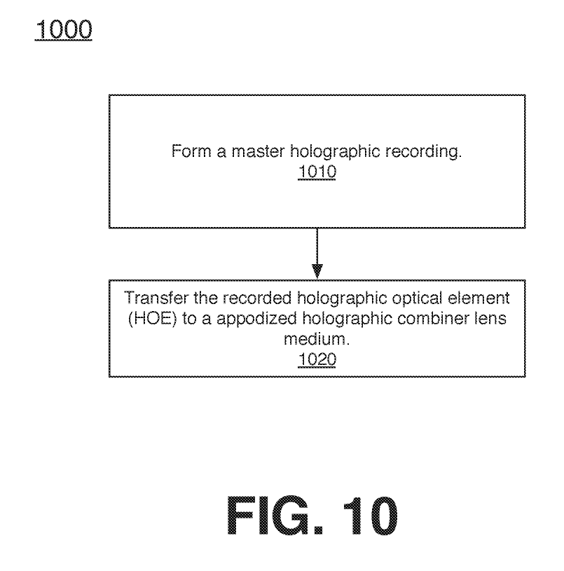

FIG. 10 depicts a logic flow 1000 for manufacturing an appodized holographic combiner lens as described herein. For example, the logic flow 1000 may be provided to manufacture the lens 120 (e.g., having a linearly or non-linearly varying reflectivity). The logic flow 1000 may begin at block 1010. At block 1010 “Form a master holographic recording.” At block 1010 a master holographic optical element is generated to include a variable level of diffraction efficiency and/or reflection efficiency across the active area of the holographic optical element (HOE). With some examples, the master HOE may be formed by varying the recording intensities, by spatially modulating the recording intensities, or the like. With some examples, the recording intensities may be spatially modulated in an inverse proportion to a target diffraction intensity.

With some examples, the spatial modulation of the recording intensities may be achieved by spatially modulating the light of an object beam incident on the recording medium and/or by spatially modulating the light of a reference beam incident on the recording medium.

With some examples, a manufacturing system may include light sources to emit object and reference beams at a recording medium. Additionally, the system can include a light modulator (e.g., comprising optical lenses, diffusers, diffractors, absorbers, or the like) to introduce a spatial modulation of the intensity profile in the recording beams. With some examples the components of the light modulator (e.g., the absorbers, or the like) may be spatially distributed within the modulator.

Continuing to block 1020 “transfer the recorded holographic optical element (HOE) to a appodized holographic combiner lens medium.” The master recording, and particularly the intensity profile may be transferred (e.g., via copying the diffraction profile of the master into a photosensitive material in an appodized holographic combiner lens.

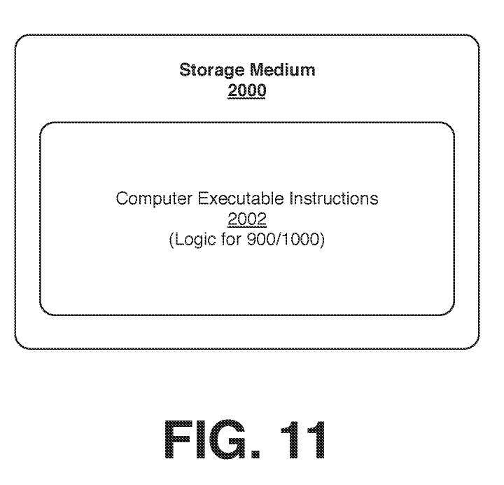

FIG. 11 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). In some examples, the storage medium 2000 may store various types of computer executable instructions to implement logic flow 900. In some examples, the storage medium 2000 may store various types of computer executable instructions to implement logic flow 1000.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

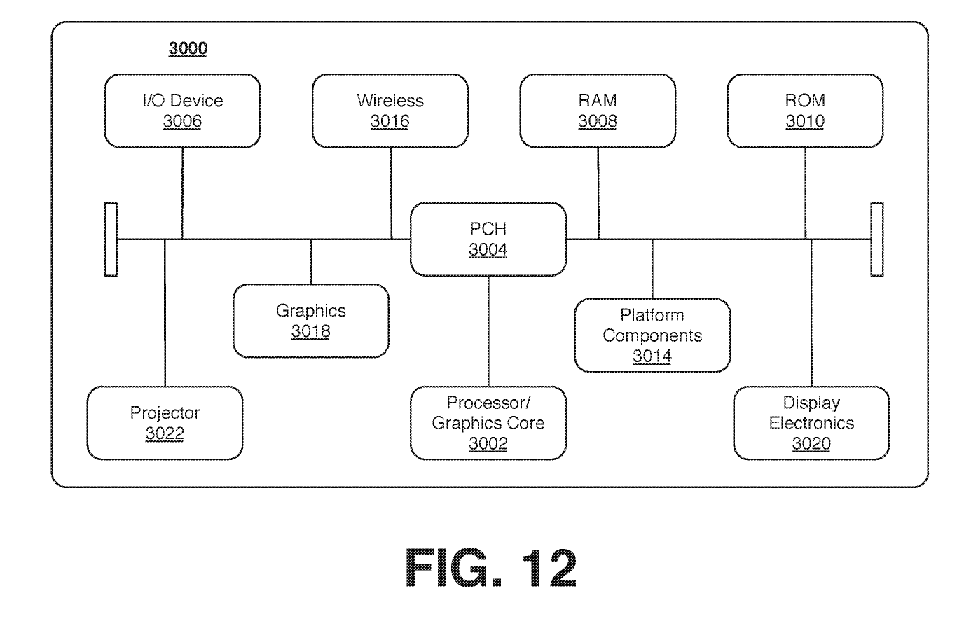

FIG. 12 is a diagram of an exemplary system embodiment and in particular, depicts a platform 3000, which may include various elements. For instance, this figure depicts that platform (system) 3000 may include a processor/graphics core 3002, a chipset/platform control hub (PCH) 3004, an input/output (I/O) device 3006, a random access memory (RAM) (such as dynamic RAM (DRAM)) 3008, and a read only memory (ROM) 3010, display electronics 3020, projector 3022 (e.g., including appodized holographic combiner lens 120, or the like), and various other platform components 3014 (e.g., a fan, a cross flow blower, a heat sink, DTM system, cooling system, housing, vents, and so forth). System 3000 may also include wireless communications chip 3016 and graphics device 3018. The embodiments, however, are not limited to these elements.

As depicted, I/O device 3006, RAM 3008, and ROM 3010 are coupled to processor 3002 by way of chipset 3004. Chipset 3004 may be coupled to processor 3002 by a bus 3012. Accordingly, bus 3012 may include multiple lines.

Processor 3002 may be a central processing unit comprising one or more processor cores and may include any number of processors having any number of processor cores. The processor 3002 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 3002 may be multiple separate processors located on separate integrated circuit chips. In some embodiments processor 3002 may be a processor having integrated graphics, while in other embodiments processor 3002 may be a graphics core or cores.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### Example 1

An apparatus, comprising: an appodized holographic combiner lens, the appodized holographic combiner lens comprising a reflective portion to receive a plurality of light beams across the reflective portion and to reflect a portion of each of the plurality of light beams differently based in part on where on the reflective portion each of the plurality of light beams are incident.

### Example 2

The apparatus of example 1, wherein a first light beam of the plurality of light beam is incident on the reflective portion in a first area and a second light beam of the plurality of light beams is incident on the reflective portion in a second area, the reflective portion to reflect a first portion of the first light beam and a second portion of the second light beam, where the first portion is different than the second portion.

### Example 3

The apparatus of example 1, the reflective portion to reflect a portion of each of the plurality of light beams non-linearly based on based on where on the reflective portion each of the plurality of light beams is incident.

### Example 4

The apparatus of example 1, the reflective portion to reflect a portion of each of the plurality of light beams linearly based on based on where on the reflective portion each of the plurality of light beams is incident.

### Example 5

The apparatus of example 1, the reflective portion to reflect a portion of each of the plurality of light beams non-linearly based on based on where on the reflective portion each of the plurality of light beams is incident, wherein the plurality of light beams have a non-linear intensity based in part on where on the reflective portion each of the plurality of light beams is incident.

### Example 6

The apparatus of any one of examples 1 to 5, wherein the reflective portion comprises a photosensitive material, the photosensitive material to have a variable level of reflection efficiency across the appodized holographic combiner lens.

### Example 7

The apparatus of any one of examples 1 to 5, wherein the reflective portion reflects a portion of each of the plurality of light beams in increasing amounts across a horizontal plane of the appodized holographic combiner lens.

### Example 8

The apparatus of any one of examples 1 to 5, wherein the reflective portion reflects a portion of each of the plurality of light beams in increasing amounts across a vertical plane of the appodized holographic combiner lens.

### Example 9

A system comprising: a frame; and an appodized holographic combiner lens coupled to the frame, the appodized holographic combiner lens comprising a reflective portion to receive a plurality of light beams across the reflective portion and to reflect a portion of each of the plurality of light beams differently based in part on where on the reflective portion each of the plurality of light beams are incident.

### Example 10

The system of example 9, comprising a projection system coupled to the frame, the projection system to emit the plurality of light beams.

### Example 11

The system of example 9, wherein a first light beam of the plurality of light beam is incident on the reflective portion in a first area and a second light beam of the plurality of light beams is incident on the reflective portion in a second area, the reflective portion to reflect a first portion of the first light beam and a second portion of the second light beam, where the first portion is different than the second portion.

### Example 12

The system of example 9, the reflective portion to reflect a portion of each of the plurality of light beams non-linearly based on based on where on the reflective portion each of the plurality of light beams is incident.

### Example 13

The system of example 9, the reflective portion to reflect a portion of each of the plurality of light beams linearly based on based on where on the reflective portion each of the plurality of light beams is incident.

### Example 14

The system of example 9, the reflective portion to reflect a portion of each of the plurality of light beams non-linearly based on based on where on the reflective portion each of the plurality of light beams is incident, wherein the plurality of light beams have a non-linear intensity based in part on where on the reflective portion each of the plurality of light beams is incident.

### Example 15

The system of any one of examples 9 to 14, wherein the reflective portion comprises a photosensitive material, the photosensitive material to have a variable level of reflection efficiency across the appodized holographic combiner lens.

### Example 16

The system of any one of examples 9 to 14, wherein the reflective portion reflects a portion of each of the plurality of light beams in increasing amounts across a horizontal plane of the appodized holographic combiner lens.

### Example 17

The system of any one of examples 9 to 14, wherein the reflective portion reflects a portion of each of the plurality of light beams in increasing amounts across a vertical plane of the appodized holographic combiner lens.

### Example 18

The system of any one of example 9 to 14, wherein frame is a frame for a head worn display or a heads up display.

### Example 19

The system of any one of examples 9 to 14, wherein the frame is a glasses frame, a goggles frame, a helmet frame, or a visor frame.

### Example 20

The system of any one of examples 9 to 14, wherein the appodized holographic combiner lens is a glasses lens, a goggles lens, a windshield, or a helmet visor.

### Example 21

A method to project a virtual image, the method comprising: receiving a plurality of light beams at an appodized holographic combiner lens, the plurality of light beams incident across the appodized holographic combiner lens; and reflecting, differently for each of the plurality of light beams, a portion of the light beam based in part on where on the appodized holographic combiner lens the light beam is incident.

### Example 22

The method of example 21, wherein a first light beam of the plurality of light beam is incident on the appodized holographic combiner lens in a first area and a second light beam of the plurality of light beams is incident on the appodized holographic combiner lens in a second area, reflecting, for each of the plurality of light beams, the portion of the light beam comprising: reflecting a first portion of the first light beam; and reflecting a second portion of the second light beam different than the first portion.

### Example 23

The method of example 21, reflecting, for each of the plurality of light beams, the portion of the light beam non-linearly based on based on where on the appodized holographic combiner lens each of the plurality of light beams is incident.

### Example 24

The method of example 23, wherein the plurality of light beams have non-linear intensity based in part on where on the reflective portion each of the plurality of light beams is incident, and wherein the reflecting the portion of the light beams non-linearly is inverse to the non-linear intensity.

### Example 25

The method of example 21, reflecting, for each of the plurality of light beams, the portion of the light beam linearly based on based on where on the appodized holographic combiner lens each of the plurality of light beams is incident.

### Example 26

The method of any one of examples 21 to 25, wherein the reflective portion comprises a photosensitive material, the photosensitive material to have a variable level of reflection efficiency across the appodized holographic combiner lens.

### Example 27

The method of any one of examples 21 to 25, reflecting, for each of the plurality of light beams, the portion of the light beam in increasing amounts across a horizontal plane of the appodized holographic combiner lens.

### Example 28

The method of any one of examples 21 to 25, reflecting, for each of the plurality of light beams, the portion of the light beam in increasing amounts across a vertical plane of the appodized holographic combiner lens.

### Example 29

An apparatus comprising means to perform the method of any one of examples 21 to 28.

### Example 30

A method of manufacturing an appodized holographic combiner lens, the method comprising: providing an appodized holographic combiner lens comprising a photosensitive material; and interfering a reference beam and one or more object beams at the appodized holographic combiner lens to modify a level of reflection efficiency across the appodized holographic combiner lens.

### Example 31

The method of example 30, wherein the level of reflection efficiency to reflect a portion of each of a plurality of incident light beams non-linearly based on based on where on the appodized holographic combiner lens each of the plurality of light beams is incident.

### Example 32

The method of example 30, wherein the level of reflection efficiency to reflect a portion of each of a plurality of incident light beams linearly based on based on where on the appodized holographic combiner lens each of the plurality of light beams is incident.

### Example 33

The method of any one of examples 30 to 32, the level of reflection efficiency increasing across a horizontal plane of the appodized holographic combiner lens.

### Example 34

The method of any one of examples 30 to 32, the level of reflection efficiency increasing across a vertical plane of the appodized holographic combiner lens.

### Example 35

A lens for a head worn display or a heads up display prepared by the method of any one of examples 30 to 34.

1-25. (canceled)

26. An apparatus, comprising:
an appodized holographic combiner lens, the appodized holographic combiner lens comprising a reflective portion to receive a plurality of light beams across the reflective portion and to reflect the plurality of light beams as diffracted light, at least one of the plurality of light beams to be incident on the appodized holographic combiner lens with a different intensity than another one of the plurality of light beams, the reflective portion to reflect a portion of each of the plurality of light beams differently based in part on where on the reflective portion each of the plurality of light beams are incident such that the diffracted light comprises light beams of substantially uniform intensity.

27. The apparatus of claim 26, wherein a first light beam of the plurality of light beam is incident on the reflective portion in a first area and a second light beam of the plurality of light beams is incident on the reflective portion in a second area, the reflective portion to reflect a first portion of the first light beam and a second portion of the second light beam, where the first portion is different than the second portion.

28. The apparatus of claim 26, the reflective portion to reflect a portion of each of the plurality of light beams linearly based on where on the reflective portion each of the plurality of light beams is incident.

29. The apparatus of claim 26, wherein the reflective portion comprises a photosensitive material, the photosensitive material to have a variable level of reflection efficiency across the appodized holographic combiner lens.

30. The apparatus of claim 26, wherein the reflective portion reflects a portion of each of the plurality of light beams in increasing amounts across a horizontal plane of the appodized holographic combiner lens.

31. The apparatus of claim 26, wherein the reflective portion reflects a portion of each of the plurality of light beams in increasing amounts across a vertical plane of the appodized holographic combiner lens.

32. A system comprising:
a frame; and
an appodized holographic combiner lens coupled to the frame, the appodized holographic combiner lens comprising a reflective portion to receive a plurality of light beams across the reflective portion and to reflect the plurality of light beams as diffracted light, at least one of the plurality of light beams to be incident on the appodized holographic combiner lens with a different intensity than another one of the plurality of light beams, the reflective portion to reflect a portion of each of the plurality of light beams differently based in part on where on the reflective portion each of the plurality of light beams are incident such that the diffracted light comprises light beams of substantially uniform intensity.

33. The system of claim 32, comprising a projection system coupled to the frame, the projection system to emit the plurality of light beams.

34. The system of claim 32, wherein a first light beam of the plurality of light beam is incident on the reflective portion in a first area and a second light beam of the plurality of light beams is incident on the reflective portion in a second area, the reflective portion to reflect a first portion of the first light beam and a second portion of the second light beam, where the first portion is different than the second portion.

35. The system of claim 32, the reflective portion to reflect a portion of each of the plurality of light beams linearly based on where on the reflective portion each of the plurality of light beams is incident.

36. The system of claim 32, wherein the reflective portion comprises a photosensitive material, the photosensitive material to have a variable level of reflection efficiency across the appodized holographic combiner lens.

37. The system of claim 32, wherein the reflective portion reflects a portion of each of the plurality of light beams in increasing amounts across a horizontal plane of the appodized holographic combiner lens.

38. The system of claim 32, wherein the reflective portion reflects a portion of each of the plurality of light beams in increasing amounts across a vertical plane of the appodized holographic combiner lens.

39. The system of claim 32, wherein frame is a frame for a head worn display or a heads up display.

40. The system of claim 32, wherein the frame is a glasses frame, a goggles frame, a helmet frame, or a visor frame.

41. The system of claim 32, wherein the appodized holographic combiner lens is a glasses lens, a goggles lens, a windshield, or a helmet visor.

42. A method to project a virtual image, the method comprising:
receiving a plurality of light beams at an appodized holographic combiner lens, the plurality of light beams to be incident across the appodized holographic combiner lens, at least one of the plurality of light beams to be incident on the appodized holographic combiner lens with a different intensity than another one of the plurality of light beams; and
reflecting, differently for each of the plurality of light beams, a portion of the light beam based in part on where on the appodized holographic combiner lens the light beam is incident as diffracted light, the diffracted light to comprise light beams of substantially uniform intensity.

43. The method of claim 42, wherein a first light beam of the plurality of light beam is incident on the appodized holographic combiner lens in a first area and a second light beam of the plurality of light beams is incident on the appodized holographic combiner lens in a second area, reflecting, for each of the plurality of light beams, the portion of the light beam comprising:
reflecting a first portion of the first light beam; and
reflecting a second portion of the second light beam different than the first portion.

44. The method of claim 42, reflecting, for each of the plurality of light beams, the portion of the light beam linearly based on where on the appodized holographic combiner lens each of the plurality of light beams is incident.

45. The apparatus of claim 26, the plurality of light beams corresponding to an image to be displayed on a heads up display, the diffracted light used to display the image having a substantially uniform intensity.

46. The system of claim 39, comprising a display coupled to the frame, the plurality of light beams corresponding to an image to be displayed on the display, the diffracted light used to display the image having a substantially uniform intensity.

47. The system of claim 40, comprising a display coupled to the frame, the plurality of light beams corresponding to an image to be displayed on the display, the diffracted light used to display the image having a substantially uniform intensity.

48. The method of claim 42, the plurality of light beams corresponding to an image to be displayed on a heads up display, the diffracted light used to display the image having a substantially uniform intensity.
